(19) United States
(12) Patent Application Publication
(10) Pub. No.: US 2016/0216821 A1
(43) Pub. Date: Jul. 28, 2016

(54) OPTICAL ADHESIVE, PANEL AND METHOD FOR BONDING SUBSTRATES

(71) Applicant: TPK Touch Solutions (Xiamen) Inc., Xiamen (CN)

(72) Inventors: Yuh-Wen Lee, Hsinchu (TW); Xianbin Xu, Xiamen (CN); Fengming Lin, Fujian (CN)

(21) Appl. No.: 14/997,593

(22) Filed: Jan. 18, 2016

(30) Foreign Application Priority Data
Jan. 26, 2015 (CN) 201510036964.6

(51) Int. Cl. G06F 3/041; C09J 7/02

(52) U.S. Cl. CPC G06F 3/0412; C09J 7/02; G06F 2203/04103; C09J 2201/122; C09J 2201/28

(57) ABSTRACT

An optical adhesive includes a first surface, a second surface, and plural first recessed strips. The first surface is opposite to the first surface. The first recessed strips of the optical adhesive are disposed on the first surface. The optical adhesive has a transmittance greater than 80% in a visible spectrum.

### CROSS REFERENCE TO RELATED APPLICATIONS

This Non-provisional application claims priority under 35 U.S.C. §119(a) to Chinese Patent Application No. 201510036964.6 filed in the People's Republic of China on Jan. 26, 2015, the entire contents of which are hereby incorporated by reference.

### BACKGROUND OF THE DISCLOSURE

1. Field of the Disclosure

The present disclosure relates to a method for bonding substrates. More particularly, the present disclosure relates to an optical adhesive, a panel bonded through the application of the optical adhesive, and a method for bonding substrates.

2. Description of the Related Art

Improvement in displays has brought growth in related industries. In the display industry, different substrates are often bonded together to achieve various purposes and effects. For example, a display panel and a touch panel are bonded together to form a touch display device, which has functions of displaying and touching. Alternatively, a display panel is bonded with other glasses to form a display device with enhanced impact resistance. Moreover, inner functional layers of a touch panel are bonded with each other.

Often, optical clear adhesive is utilized for bonding two substrates. However, in the bonding process, if the surface of the substrate is not flat enough, air remains between the optical clear adhesive and the substrate and forms bubbles, which are hard to remove. The bubbles may change the refractive index that light experiences, and have a great influence on image quality.

### SUMMARY OF THE DISCLOSURE

Embodiments of the present disclosure provide a method for bonding substrates, and an optical adhesive configured with recessed strips is utilized in the method. In the pressurization of bonding substrates, bubbles are expelled from the recessed strips, and the optical adhesive is heated and pressurized to deform and close the recessed strips.

According to one embodiment of the present disclosure, an optical adhesive includes a first surface, a second surface opposite to the first surface, and plural first recessed strips. The first recessed strips are disposed on the first surface. The optical adhesive has a transmittance greater than 80% in a visible spectrum.

In some embodiments of the present disclosure, a side of the first recessed strips adjacent to the first surface has an opening width greater than an opening width of the other side of the first recessed strips away from the first surface.

In some embodiments of the present disclosure, each of the first recessed strips has a projection on a side surface of the optical adhesive, the projection has a shape of semicircle, triangle, or trapezoid, and the side surface connects the first surface and the second surface.

In some embodiments of the present disclosure, a depth of each of the first recessed strips is equal to or less than half a thickness of the optical adhesive.

In some embodiments of the present disclosure, the optical adhesive further includes plural second recessed strips disposed on the second surface.

In some embodiments of the present disclosure, a sum of a depth of each of the first recessed strips and a depth of each of the second recessed strips is equal to or less than half a thickness of the optical adhesive.

In some embodiments of the present disclosure, each of the first recessed strips has an end extending to a side surface of the optical adhesive and the other end extending to the other side surface of the optical adhesive opposite to the side surface.

In some embodiments of the present disclosure, a viscosity of the optical adhesive is in a range from 40 Newton-seconds per square centimeter to 500 Newton-seconds per square centimeter.

According to another embodiment of the present disclosure, a method for bonding substrates includes disposing an optical adhesive on a first substrate, wherein the optical adhesive includes plural first recessed strips, and the first recessed strips face the first substrate; heating the first substrate and the optical adhesive for softening the optical adhesive; and exerting a force on a side of the softened optical adhesive opposite to the first substrate such that the softened optical adhesive is deformed, thereby closing the first recessed strips.

In some embodiments of the present disclosure, a mask layer is disposed between the optical adhesive and the first substrate, and the mask layer is disposed at a periphery of the first substrate, the mask layer has at least one sidewall, wherein the step of disposing the optical adhesive on the first substrate includes disposing the first recessed strips corresponding to the sidewall, such that projections of the first recessed strips on the first substrate are at least partially overlapped with a projection of the sidewall on the first substrate.

In some embodiments of the present disclosure, the step of exerting the force on the softened optical adhesive is performed by exerting the force on an entire surface of the optical adhesive in a vacuum environment.

In some embodiments of the present disclosure, projections of the first recessed strips on the first substrate extend along a first direction, and the step of exerting the force on the softened optical adhesive is performed by moving a roller along the first direction.

According to another embodiment of the present disclosure, a panel includes a first substrate, a second substrate opposite to the first substrate, an optical adhesive, and a mask layer. The optical adhesive is disposed between the first substrate and the second substrate, and the optical adhesive includes a first surface, a second surface opposite to the first surface, and plural first recessed strips. The first recessed strips are disposed on the first surface. The optical adhesive has a transmittance greater than 80% in a visible spectrum. The mask layer is disposed between the first substrate and the optical adhesive and at a periphery of the first substrate. The mask layer has at least one sidewall, and projections of the first recessed strips on the first surface are at least partially overlapped with a projection of the sidewall on the first surface.

In some embodiments of the present disclosure, a side of the first recessed strips adjacent to the first substrate has an opening width greater than an opening width of the other side of the first recessed strips away from the first substrate.

In some embodiments of the present disclosure, projections of the first recessed strips on the substrate extend along a first direction, a projection of the sidewall on the substrate extends along a second direction, and the first direction is substantially perpendicular to the second direction.

In some embodiments of the present disclosure, projections of the first recessed strips on the substrate extend along a first direction, and a projection of the sidewall on the substrate extends along the first direction.

In some embodiments of the present disclosure, the optical adhesive includes plural second recessed strips disposed on the second surface.

In some embodiments of the present disclosure, the first substrate includes a touch-sensing layer disposed at a side of the first substrate adjacent to the optical adhesive.

In some embodiments of the present disclosure, the second substrate includes a touch-sensing layer disposed at a side of the second substrate adjacent to or away from the optical adhesive.

In some embodiments of the present disclosure, a thickness of the optical adhesive is in a range from 15 micrometers to 250 micrometers.

In some embodiments of the present disclosure, the thickness of the optical adhesive is in a range from 25 micrometers to 125 micrometers.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a stereoscopic view of an optical adhesive according to embodiments of the present disclosure;

FIG. 2A is a side view of an optical adhesive according to other embodiments of the present disclosure;

FIG. 2B is a side view of an optical adhesive according to other embodiments of the present disclosure;

FIG. 2C is a top view of an optical adhesive according to other embodiments of the present disclosure;

FIG. 3 is a stereoscopic view of an optical adhesive according to other embodiments of the present disclosure;

FIG. 4 is a flow chart of a method for bonding substrates according to other embodiments of the present disclosure;

FIG. 5A to FIG. 5E are schematic views illustrating plural steps of the method for bonding substrates of FIG. 4; and

FIG. 6 is a stereoscopic view of a panel according to other embodiments of the present disclosure.

### DETAILED DESCRIPTION OF THE DISCLOSURE

Reference will now be made in detail to embodiments of the disclosure, examples of which are illustrated in the accompanying drawings. Wherever possible, the same reference numbers are used in the drawings and the description to refer to the same or like parts.

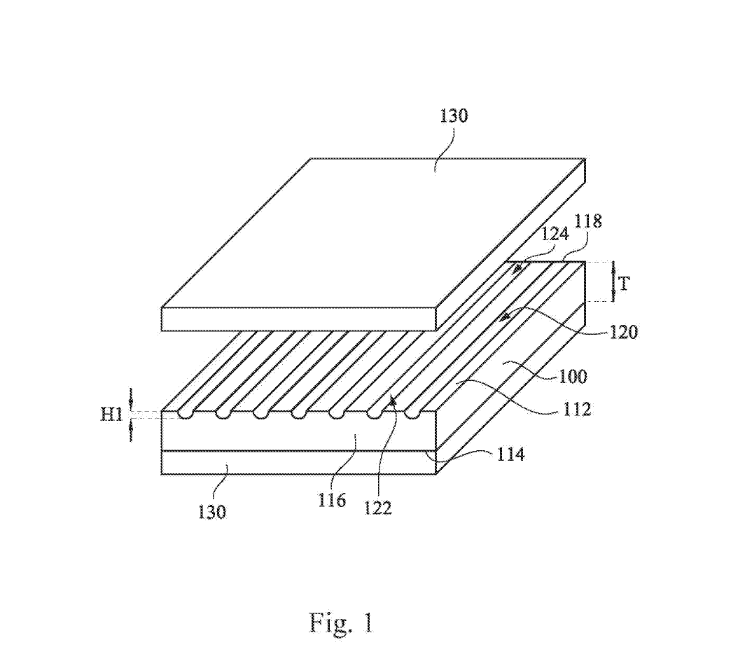

FIG. 1 is a stereoscopic view of an optical adhesive according to embodiments of the present disclosure. The optical adhesive 100 includes a first surface 112, a second surface 114 opposite to the first surface 112, and plural first recessed strips 120. The optical adhesive 100 has a transmittance greater than 80% in a visible spectrum. The first recessed strips 120 are disposed on the first surface 112. At least one of the first surface 112 and the second surface 114 is the bonding surface.

In one or more embodiments of the present disclosure, the plural first recessed strips 120 are arranged substantially parallel to each other. A side of each of the first recessed strips 120 adjacent to the first surface 112 has an opening width greater than an opening width of the other side of the first recessed strip 120 away from the first surface 112. To be specific, the farther away from the first surface, the smaller the opening width of the first recessed strips 120 becomes. The width of the first recessed strips 120 decreases from the outside (the first surface 112) to the inside (the inner of the optical adhesive 100).

In one or more embodiments of the present disclosure, a depth H1 of each of the first recessed strips 120 is equal to or less than half a thickness T of the optical adhesive 100.

In one or more embodiments, each of the first recessed strips 120 has an end 122 extending to a side surface 116 of the optical adhesive 100 and the other end 124 extending to the other side surface 118 of the optical adhesive 100, in which the side surface 116 is opposite to the side surface 118, and the side surface 116 or the side surface 118 connects the first surface 112 and the second surface 114. In other words, the first recessed strips 120 connects two opposite side surfaces 116 and 118 of the optical adhesive 100, such that bubbles in the first recessed strips 120 can be exhausted from the side surface 116 or the side surface 118 through/along the first recessed strips 120.

Plural release films 130 may be disposed on the surfaces of the optical adhesive 100 for preventing pollution or oxidation of the optical adhesive 100 and maintaining the viscosity of the optical adhesive 100. For example, the release films 130 may be respectively disposed on the first surface 112 and the second surface 114 of the optical adhesive 100. In some embodiments, the material of the optical adhesive 100 is a poly acrylic acid or other acrylic resin. At room temperature(ex. 20˜27° C.), the optical adhesive 100 is viscous solid material, and it is not necessary to perform a light-curing process for transforming the optical adhesive 100 from a liquid state to a solid state. In some embodiments, a heating process is performed to melt or soften the optical adhesive 100. The viscosity of the optical adhesive 100 is in a range from 40 Newton-seconds per square centimeter (N·s/cm2) to 500 Newton-seconds per square centimeter (N·s/cm2), and preferably in a range from 135 Newton-seconds per square centimeter (N·s/cm2) to 165 Newton-seconds per square centimeter (N·s/cm2).

Through the configuration, when the optical adhesive 100 is bonded to the substrate, air between the optical adhesive 100 and the substrate is extruded into the first recessed strips 120. Next, the optical adhesive 100 may be melted or softened by the heating process. Subsequently, pressurization may deform the optical adhesive 100, thereby closing the first recessed strips 120, and the air may be exhausted from the side surface 116 or the side surface 118 through the first recessed strips 120.

Since the optical adhesive 100 is substantially in a solid state, the degree of deformation is limited, and it is a design consideration whether the deformation of the optical adhesive 100 may close the first recessed strips 120 through the heating and pressurization. Herein, the first recessed strips 120 are configured to be expanding structures, and the depth thereof is limited, such that the first recessed strips 120 may be closed by the deformation through the heating and pressurization. Moreover, the expanding structure of the first recessed strips 120 benefits the exhaustion of gas. In the absence of the expanding structure, the gas may be encapsulated to form bubbles in the first recessed strips 120 since narrow parts of the first recessed strips 120 are sealed in advance, and the bubbles have an influence on the light transmitted through the optical adhesive 100.

In one or more embodiments, each of the first recessed strips 120 has a projection on the side surface 116, and the projection has a shape of semicircle, but it should not limit the scope of the present disclosure. The cross-sectional shape of the first recessed strips 120 may be triangle, trapezoid, etc. The cross-sectional shape of the first recessed strips 120 may be various, and preferably, the closer to the bonding surface, which is the first surface 112, the greater the opening width of the first recessed strips 120.

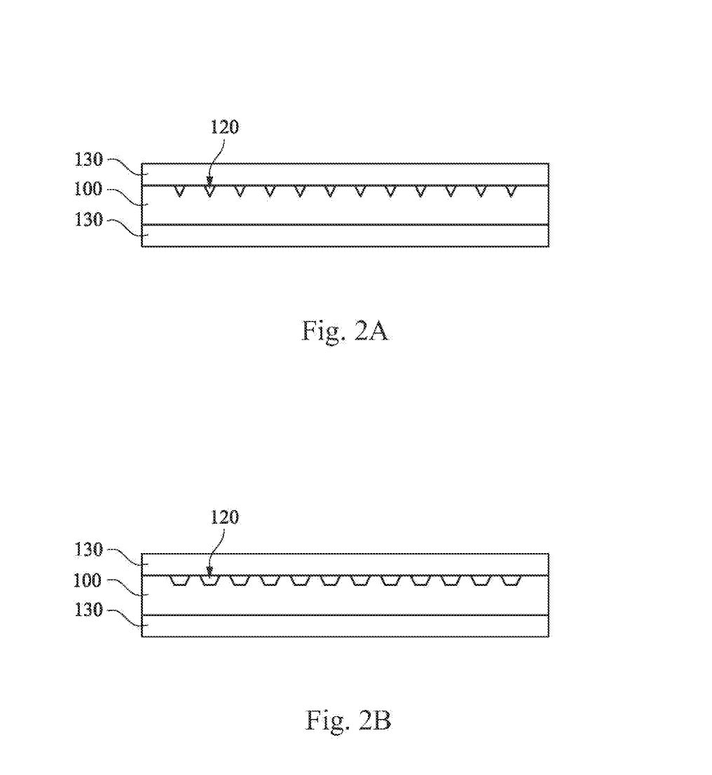

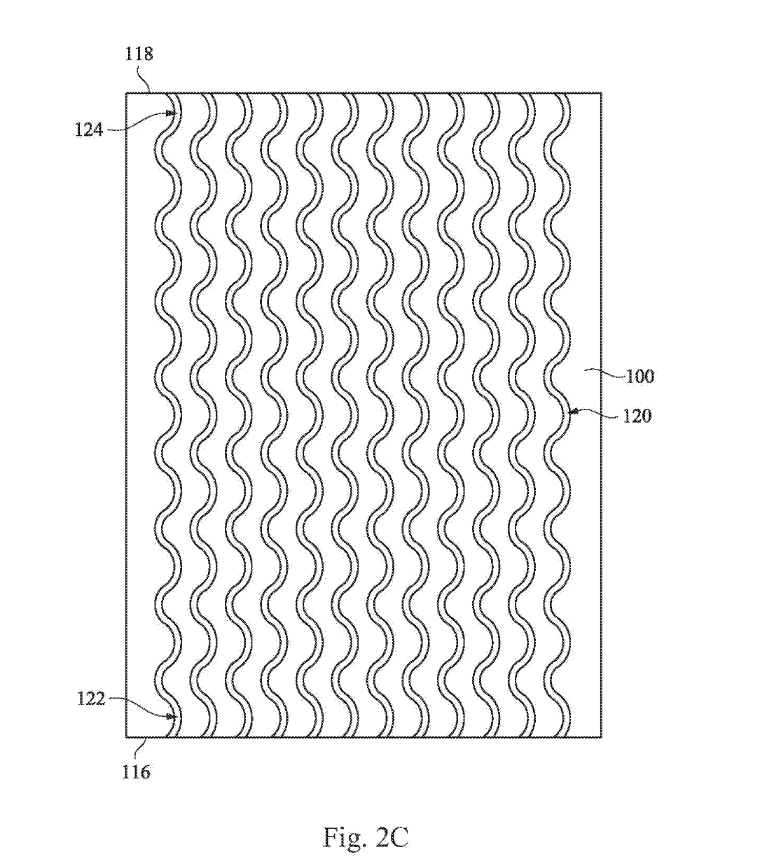

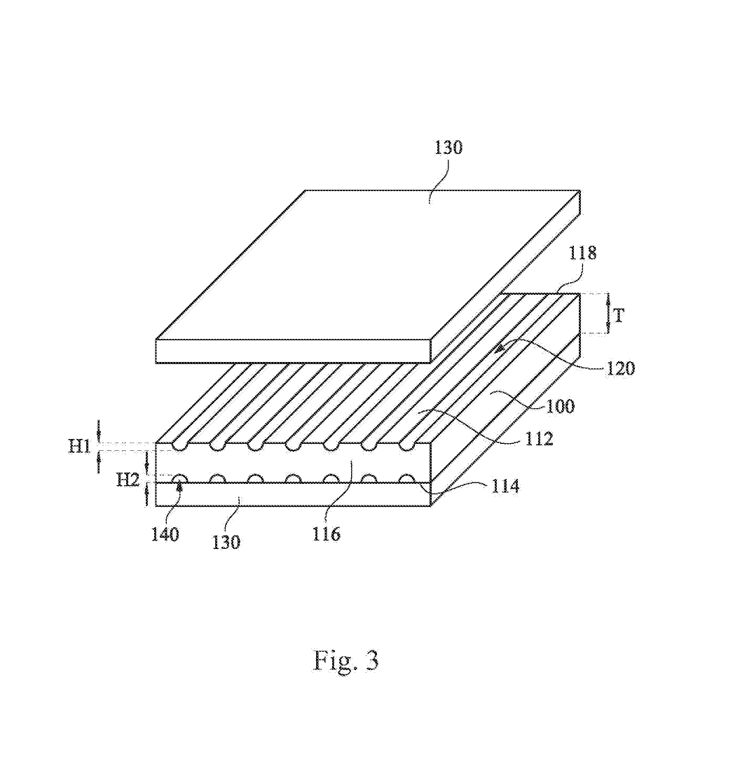

FIG. 2A is a side view of an optical adhesive according to other embodiments of the present disclosure. The configuration is similar to that shown in FIG. 1, and the difference is that in FIG. 2A, the cross-sectional shape of the first recessed strips 120 is triangular. Other details are substantially similar to those illustrated in FIG. 1, and are not repeated herein.

FIG. 2B is a side view of an optical adhesive according to other embodiments of the present disclosure. The configuration of FIG. 2B is similar to that of FIG. 1, and the difference is that the cross-sectional shape of the first recessed strips 120 is trapezoidal in FIG. 2B. As shown in FIG. 2B, the opening width of a side of the first recessed strips 120 adjacent to the upper release film 130 is greater than the opening width of the other side of the first recessed strips 120 away from the upper release film 130. Other details are substantially similar to those illustrated in FIG. 1, and are not repeated herein.

FIG. 2C is a top view of an optical adhesive according to various embodiments of the present disclosure. The configuration of FIG. 2C is similar to that of FIG. 1, and the difference is that the cross-sectional shape of the first recessed strips 120 is sinusoidal and periodic. Herein, for clear illustration, the release films are not depicted in FIG. 2C.

Similarly, in some embodiments, each of the first recessed strips 120 has an end 122 extending to the side surface 116 of the optical adhesive 100 and the other end 124 extending to the other side surface 118 of the optical adhesive 100, in which the side surface 116 is opposite to the side surface 118.

Through the configuration, when the optical adhesive 100 is bonded to the substrate, air between the optical adhesive 100 and the substrate is extruded into the first recessed strips 120. Subsequently, through heating and pressurization, the optical adhesive 100 may deform and close the first recessed strips 120, and the air may be exhausted from the side surface 116 or the side surface 118 of the optical adhesive 100 through the first recessed strips 120.

Other details are substantially similar to those illustrated in the embodiment of FIG. 1, and thereto not repeated herein.

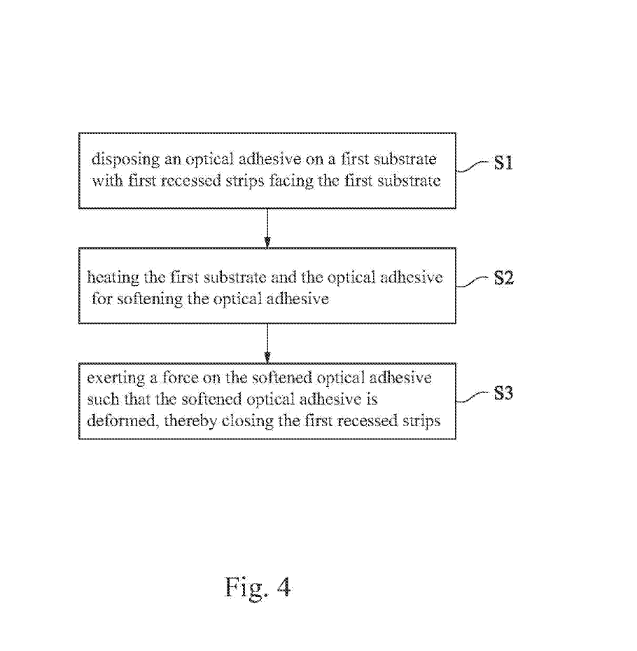

FIG. 3 is a stereoscopic view of an optical adhesive 100 according to other embodiments of the present disclosure. The configuration of FIG. 3 is similar to that of FIG. 1, and the difference is that: in some embodiments, the optical adhesive 100 further includes plural second recessed strips 140 disposed on the second surface 114.

Similarly, in the present disclosure, the plural second recessed strips 140 are arranged substantially parallel to each other. Each of the second recessed strips 140 has an end extending to the side surface 116 of the optical adhesive 100 and the other end extending to the other side surface 118 of the optical adhesive 100, in which the side surface 116 is opposite to the side surface 118.

In at least one embodiment of the present disclosure, a sum of the depth H1 of the first recessed strips 120 and a depth H2 of each of the second recessed strips 140 is equal to or less than half a thickness T of the optical adhesive 100. In some embodiments, the first recessed strips 120 and the second recessed strips 140 have projections on the release films 130. Preferably, the projections of the first recessed strips 120 and the projections of the second recessed strips 140 may extend substantially along the same direction, such that components can be bonded to two opposite sides of optical adhesive at the same time. However, it should not limit the scope of the present disclosure. In some embodiments, according to types of the bonding methods, the projections of the first recessed strips 120 on the release films 130 may extend along a direction different from the direction that the projections of the second recessed strips 140 on the release films 130 extend along.

As a result, two different substrates may be bonded together through the optical adhesive 100, and air between the optical adhesive 100 and one of the substrates is reduced or eliminated through the configuration of the first recessed strips 120 and the second recessed strips 140.

Other details are substantially similar to those illustrated in the embodiment of FIG. 1, and therefore not repeated herein.

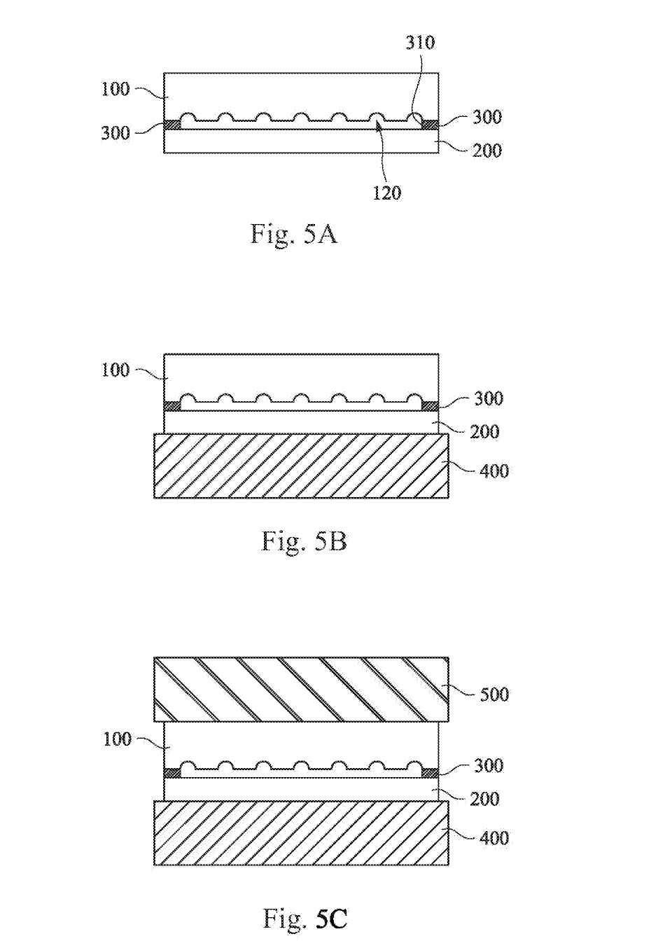

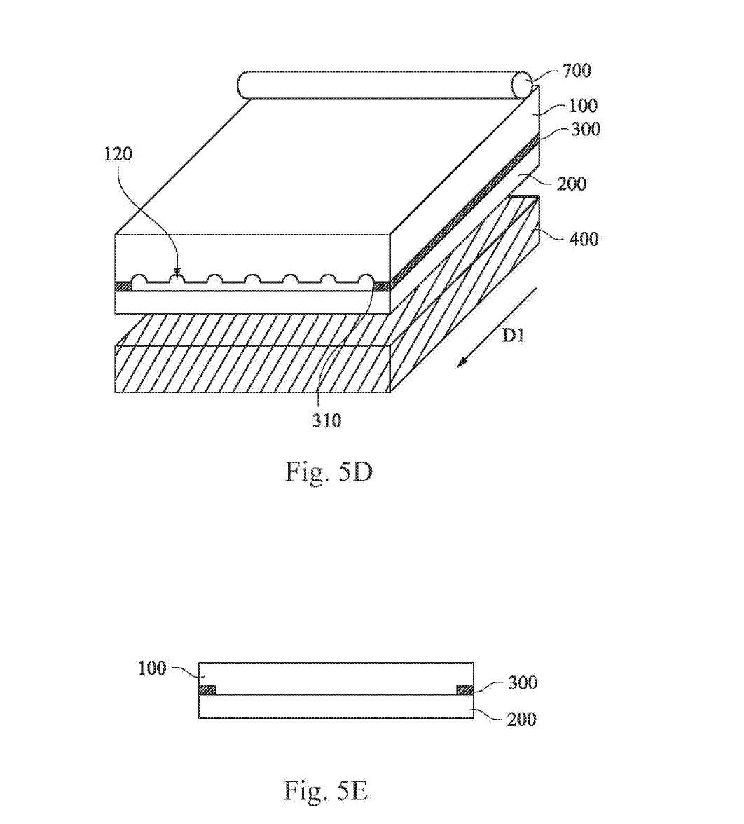

FIG. 4 is a flow chart of a method for bonding substrates according to various embodiments of the present disclosure. FIG. 5A to FIG. 5E are schematic views illustrating steps of the method for bonding substrates of FIG. 4. The method for bonding substrates includes steps S1˜S3, and these steps may be utilized in the bonding process of panels.

Reference is made to both FIG. 5A and FIG. 4. First, beginning at the step S1, the optical adhesive 100 is disposed on a first substrate 200. The first substrate 200 may be a cover plate of a touch panel, or a carrier substrate on which a touch-sensing layer is disposed. The optical adhesive 100 includes plural first recessed strips 120 facing the first substrate 200. It is noted that the unused optical adhesive 100 should include release films, as the optical adhesive 100 shown in FIG. 1, but in some embodiments, for bonding substrates through the optical adhesive 100, the release films on the bonding surface of the optical adhesive 100 are already removed. Herein, though the release films are not shown, it is noted that a release film may be disposed on a side of the optical adhesive 100 where no component is bonded. Whether the release film is disposed on the optical adhesive 100 should not limit the scope of the present disclosure.

Usually, bubbles are easily generated when a bonding surface of the bonding component is not flat. In some embodiments, for illustrating the bonding process, a mask layer 300 is disposed on the bonding surface of the first substrate 200, but it is noted that the configuration of the mask layer 300 should not limit the scope of the present disclosure. The mask layer 300 is disposed between the first substrate 200 and the optical adhesive 100, and the mask layer 300 is disposed at the periphery of the first substrate 200 for shielding relevant electric circuits. The mask layer 300 includes at least one sidewall 310. In at least one embodiment of the present disclosure, when the optical adhesive 100 is disposed on the first substrate 200, one of the first recessed strips 120 may be disposed corresponding to the sidewall 310. For example, as shown in FIG. 5A, an edge of one of the first recessed strips 120 is aligned with the sidewall 310. In actual application, the edge of the first recessed strips 120 is not limited to be aligned with the sidewall 310. In at least one embodiment of the present disclosure, in actual configuration, projections of the first recessed strips 120 on the first substrate 200 are at least partially overlapped with a projection of the sidewall 310 on the first substrate 200.

In some embodiments of the present disclosure, the material of the mask layer 300 may be white ink, white photoresist, black ink, or black photoresist. The thickness of the mask layer 300 varies according to the material of the mask layer 300. The mask layer 300 is thick enough to absorb light and shield relevant electric circuits. Generally, the thickness of the mask layer 300 is in a range from about 10 nanometers to about 100 nanometers.

Next, reference is made to both FIG. 5B and FIG. 4. At the step S2, the first substrate 200 and the optical adhesive 100 are heated for softening the optical adhesive 100. Herein, the heating process is performed by placing the first substrate 200 and the optical adhesive 100 thereon onto a heating machine 400, and heat energy is transferred to the optical adhesive 100 by heat conduction and convection. It is noted that, the heating process of the present disclosure is not limited thereto, and the first substrate 200 and the optical adhesive 100 thereon may be placed into a heating chamber and have a uniform heating profile.

In one or more embodiments of the present disclosure, the optical adhesive 100 has certain viscosity. As illustrated in FIG. 1, the optical adhesive 100 is substantially at solid state, and the softened optical adhesive 100 is at a molten state and has a slight capability of deformation.

Subsequently, reference is made to FIG. 5C and FIG. 4. At the step S3, a force is exerted on the softened optical adhesive 100 such that the softened optical adhesive 100 is deformed, thereby closing the first recessed strips 120.

In one or more embodiments of the present disclosure, the step of exerting the force is performed after the air surrounding the softened optical adhesive 100 is evacuated to create a vacuum environment. Through assistance of the vacuum environment, the bubbles may be guided and expelled out effectively.

In some embodiments, the force is exerted on a side of the optical adhesive 100 opposite to the first substrate 200 through the pressure plate 500, but the scope of the present disclosure should not be limited thereto.

In some embodiments, the force may be indirectly exerted on the side of the optical adhesive 100 opposite to the first substrate 200 through the pressure plate 500. For example, there may be another plate disposed on the side of the optical adhesive 100 opposite to the first substrate 200, such as a release film (not shown) or a second substrate (not shown). The step of exerting the force may be performed by utilizing the pressure plate 500 to press the release film or the second substrate, and therefore the optical adhesive 100 and the first substrate 200 are bonded.

In some embodiments, the step of exerting the force on the softened optical adhesive 100 is performed by exerting the force on an entire surface of the optical adhesive 100. It is noted that the step of exerting the force is not limited to exerting the force on the entire surface of the optical adhesive 100.

In some embodiments, the step S3 is performed by a multistage press. Reference is made to FIG. 5D and FIG. 4. A roller 700 is utilized to conduct the multistage pressing. The projections of the first recessed strips 120 on the first substrate 200 extend along a first direction D1. The roller 700 moves along the first direction D1 such that air is extruded, and therefore the air moves in the first recessed strips 120 along the first direction D1 and is exhausted.

Through the configuration of the mask layer 300, the surface that the optical adhesive 100 touches is not flat. As a result, when the mask layer 300, the first substrate 200, and the optical adhesive 100 are bonded together, at a portion of the bonding region, the mask layer 300, the first substrate 200, the optical adhesive 100 are bonded, and at another portion of the bonding region, only the first substrate 200 and the optical adhesive 100 are bonded. Therefore, air may stay at the boundary due to the configuration of the mask layer 300, in which the configuration of the mask layer 300 results in the difference of the thickness of the component to be bonded.

In some embodiments, through the design of the first recessed strips 120, the air adjacent to the mask layer 300 is guided and not encapsulated by the optical adhesive 100 or unmoved, through the pressurization and evacuation, such that the air may be exhausted along first recessed strips 120.

FIG. 5E is a side view showing a bonding structure of the optical adhesive 100 and the first substrate 200. After the heating, pressurization, and evacuation, air is not stranded between the first substrate 200 and the optical adhesive 100, and the first recessed strips close and disappear. As a result, the optical adhesive 100 and the first substrate 200 are bonded together directly.

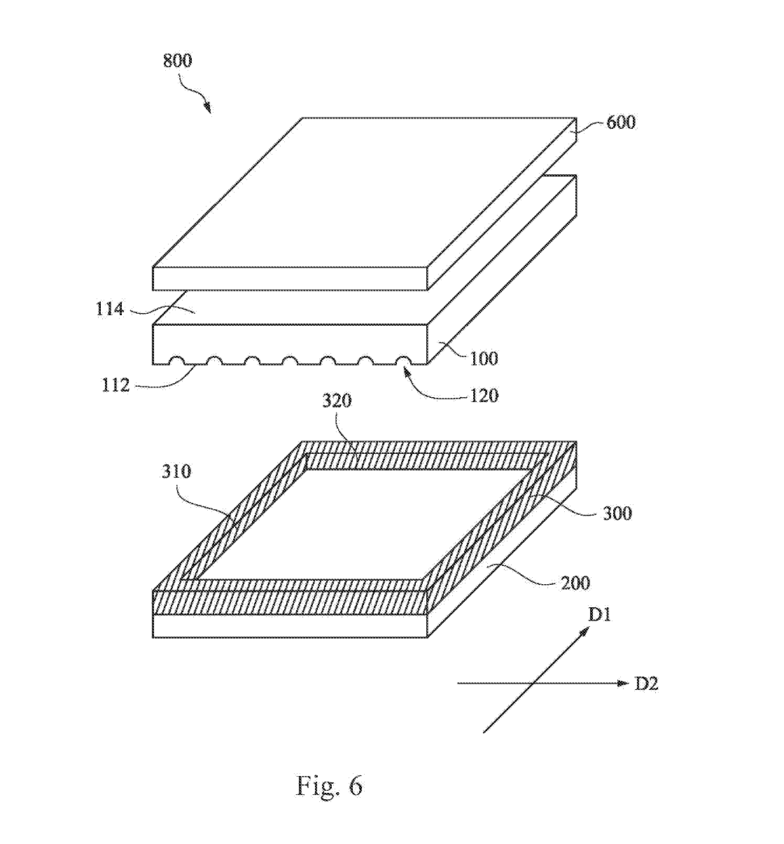

FIG. 6 is a stereoscopic view of a panel 800 according to another embodiment of the present disclosure. The panel 800 may be a touch panel, a display panel, or a touch display panel. In some embodiments, the panel 800 shown in the figure is an intermediate structure in the bonding process. In one or more embodiments of the present disclosure, the panel 800 includes a first substrate 200, a second substrate 600, an optical adhesive 100, and a mask layer 300. The second substrate 600 is opposite to the first substrate 200. The optical adhesive 100 is disposed between the first substrate 200 and the second substrate 600. The optical adhesive 100 includes a first surface 112 and a second surface 114 opposite to the first surface 112, and the optical adhesive 100 has a transmittance greater than 80% in a visible spectrum. Plural first recessed strips 120 are disposed on the first surface 112. The mask layer 300 is disposed between the first substrate 200 and the optical adhesive 100 and at a periphery of the first substrate 200. The mask layer 300 has at least one sidewall 310, and projections of the first recessed strips 120 on the first surface 112 are at least partially overlapped with a projection of the sidewall 310 on the first surface 112.

In some embodiments of the present disclosure, the first substrate 200 may be a cover plate of a touch panel, and the second substrate 600 may include a touch-sensing layer (not shown) disposed at a side of the second substrate 600 adjacent to or away from the optical adhesive 100, but it should not limit the scope of the present disclosure. In the other embodiments, the first substrate may be a cover plate including a touch-sensing layer disposed at a side of the first substrate adjacent to the optical adhesive 100, and the second substrate 600 may be a protecting substrate or a display unit. Alternatively, the first substrate 200 may be a cover plate of a display device, and the second substrate 600 is a display unit.

In some embodiments of the present disclosure, the projections of the first recessed strips 120 on the first substrate 200 extend along a first direction D1, and the projection of the sidewall 310 on the first substrate 200 extends along the first direction D1.

In some embodiments, the mask layer 300 includes another sidewall 320. The projections of the first recessed strips 120 on the first substrate 200 extend along the first direction D1, the projection of the sidewall 320 on the first substrate 200 extends along a second direction D2, and the first direction D1 is substantially perpendicular to the second direction D2.

In the above description, the arrangement relationship of the first recessed strips 120 and the sidewalls 310 and 320 of the mask layer 300 may influence the degree of difficulty of exhausting bubbles. Though the arrangement relationship is simplified as to be parallel or orthogonal to each other herein, it should be appreciated that various configurations are not illustrated herein. It is noted that the projections of the first recessed strips 120 on the first substrate 200 are at least partially overlapped with the projection of the sidewalls 310 and 320 on the first substrate 200, thereby improving the exhaustion of the bubbles adjacent to the sidewall 310 and sidewall 320.

In the process of bonding substrates, since the configuration of the mask layer 300 results in the difference of the thickness of the component to be bonded, the air adjacent to the mask layer 300 may easily be stranded and form bubbles. In some embodiments, through the configuration of the first recessed strips 120, the bubbles adjacent to the sidewall 310 and the sidewall 320 of the mask layer 300 can be extruded into the first recessed strips 120. Through the subsequent pressurization process, the bubbles moves along the first recessed strips 120 and are expelled out, and the first recessed strips 120 close.

Often, for preventing the generation of bubbles in the optical adhesive due to the uneven bonding surface, a thicker optical adhesive may be adopted to bond two substrates. For the panel of various embodiments, gas can be exhausted through recessed portions in the bonding process of the optical adhesive, and therefore a thinner optical adhesive may be adopted for lowering the thickness of the panel. For example, the thickness of the optical adhesive 100, which refers to the distance between the first surface 112 and the second surface 114, is in a range from 15 nanometers to 250 nanometers, and preferably 25 nanometers to 125 nanometers.

It is noted that FIG. 6 is related to an intermediate structure in the bonding process of panels. After the panel 800 is processed through heating, pressurization, and evacuation, the air between the first substrate 200 and the optical adhesive 100 is expelled along the first recessed strips 120. After the bonding process, the first recessed strips 120 close and disappear, thereby preventing the generation of bubbles which influence image quality of the panel.

Other details are similar to the configuration of FIG. 1B, and therefore not repeated herein.

Although the present disclosure has been described in considerable detail with reference to certain embodiments thereof, other embodiments are possible. It will be apparent to those skilled in the art that various modifications and variations can be made to the structure of the present disclosure without departing from the scope or spirit of the disclosure. Therefore, the spirit and scope of the appended claims should not be limited to the description of the embodiments contained herein.

What is claimed is:

1. An optical adhesive, comprising:
a first surface and a second surface opposite to the first surface; and
a plurality of first recessed strips disposed on the first surface, wherein the optical adhesive has a transmittance greater than 80% in a visible spectrum.

2. The optical adhesive of claim 1, wherein a side of the first recessed strips adjacent to the first surface has an opening width greater than an opening width of the other side of the first recessed strips away from the first surface.

3. The optical adhesive of claim 2, wherein each of the first recessed strips has a projection on a side surface of the optical adhesive, the projection has a shape of semicircle, triangle, or trapezoid, and the side surface connects the first surface and the second surface.

4. The optical adhesive of claim 1, wherein a depth of each of the first recessed strips is equal to or less than half a thickness of the optical adhesive.

5. The optical adhesive of claim 1, further comprising:
a plurality of second recessed strips disposed on the second surface.

6. The optical adhesive of claim 5, wherein a sum of a depth of each of the first recessed strips and a depth of each of the second recessed strips is equal to or less than half a thickness of the optical adhesive.

7. The optical adhesive of claim 1, wherein each of the first recessed strips has an end extending to a side surface of the optical adhesive and the other end extending to the other side surface of the optical adhesive opposite to the side surface.

8. The optical adhesive of claim 1, wherein a viscosity of the optical adhesive is in a range from about 40 Newton-seconds per square centimeter to about 500 Newton-seconds per square centimeter.

9. A method for bonding substrates, comprising:
disposing an optical adhesive on a first substrate, wherein the optical adhesive comprises a plurality of first recessed strips, and the first recessed strips face the first substrate;
heating the first substrate and the optical adhesive for softening the optical adhesive; and
exerting a force on a side of the softened optical adhesive opposite to the first substrate such that the softened optical adhesive is deformed, thereby closing the first recessed strips.

10. The method of claim 9, wherein a mask layer is disposed between the optical adhesive and the first substrate, and the mask layer is disposed at a periphery of the first substrate, the mask layer has at least one sidewall, wherein the step of disposing the optical adhesive on the first substrate comprises:
disposing the first recessed strips corresponding to the sidewall, such that a plurality of projections of the first recessed strips on the first substrate are at least partially overlapped with a projection of the sidewall on the first substrate.

11. The method of claim 9, wherein the step of exerting the force on the softened optical adhesive is performed by exerting the force on an entire surface of the optical adhesive in a vacuum environment.

12. The method of claim 9, wherein a plurality of projections of the first recessed strips on the first substrate extend along a first direction, and the step of exerting the force on the softened optical adhesive is performed by moving a roller along the first direction.

13. A panel, comprising:
a first substrate;
a second substrate opposite to the first substrate;
an optical adhesive disposed between the first substrate and the second substrate, wherein the optical adhesive comprises:
a first surface and a second surface opposite to the first surface, wherein the optical adhesive has a transmittance greater than 80% in a visible spectrum; and
a plurality of first recessed strips disposed on the first surface; and
a mask layer, disposed between the first substrate and the optical adhesive and at a periphery of the first substrate, wherein the mask layer has at least one sidewall, and a plurality of projections of the first recessed strips on the first surface are at least partially overlapped with a projection of the sidewall on the first surface.

14. The panel of claim 13, wherein a side of the first recessed strips adjacent to the first substrate has an opening width greater than an opening width of the other side of the first recessed strips away from the first substrate.

15. The panel of claim 13, wherein a plurality of projections of the first recessed strips on the substrate extend along a first direction, a projection of the sidewall on the substrate extends along a second direction, and the first direction is substantially perpendicular to the second direction.

16. The panel of claim 13, wherein a plurality of projections of the first recessed strips on the substrate extend along a first direction, and a projection of the sidewall on the substrate extends along the first direction.

17. The panel of claim 13, wherein the optical adhesive comprises a plurality of second recessed strips disposed on the second surface.

18. The panel of claim 13, wherein the first substrate comprises a touch-sensing layer disposed at a side of the first substrate adjacent to the optical adhesive.

19. The panel of claim 13, wherein the second substrate comprises a touch-sensing layer disposed at a side of the second substrate adjacent to or away from the optical adhesive.

20. The panel of claim 13, wherein the thickness of the optical adhesive is in a range from 25 micrometers to 125 micrometers.
